(19) United States
(12) Patent Application Publication
(10) Pub. No.: US 2015/0275051 A1
(43) Pub. Date: Oct. 1, 2015

(54) ADHERABLE FLEXIBLE COMPOSITE SYSTEMS

(71) Applicant: Cubic Tech Corporation, Mesa, AZ (US)

(72) Inventor: Roland Joseph Downs, Mesa, AZ (US)

(73) Assignee: Cubic Tech Corporation, Mesa, AZ (US)

(21) Appl. No.: 14/430,340

(22) PCT Filed: Sep. 24, 2013
(86) PCT No.: PCT/US13/61509

§ 371 Date: Mar. 23, 2015

Related U.S. Application Data
(60) Provisional application No. 61/705,030, filed on Sep. 24, 2012.

(51) Int. Cl. C09J 7/02; B32B 27/08; B32B 27/06; B32B 37/24; B32B 37/12

(52) U.S. Cl. CPC C09J 7/0264; B32B 37/24; B32B 37/12; B32B 27/06; B32B 27/08; B32B 2305/28; B32B 2405/00

(57) ABSTRACT

The present disclosure describes adherable flexible composite systems, which in various embodiments are preformed tapes and sheets comprising lamellar arrangements of engineered flexible-composite compositions. The flexible-composite compositions can comprise non-woven or other fibers oriented into networks and embedded in various polymer compositions. In various embodiments, the polymer compositions act as adhesive layers. The system of adhearable compositions can be configured to provide a structural orientation and structurally optimized for various taped applications. In accordance with various embodiments, a composite laminate tape can comprise a first fiber matrix layer having a first side and a second side, and an adhesive layer bonded to the second side of the first fiber matrix layer. The first fiber matrix layer can be a spread filament having monofilaments therein, the monofilaments lying in a first predetermined direction within the composite laminate tape.

### CROSS-REFERENCE TO RELATED APPLICATIONS

This application is a non-provisional of, and claims priority to, U.S. Provisional Patent Application Ser. No. 61/705,030, filed Sep. 24, 2012, entitled “ADHERABLE FLEXIBLE COMPOSITE SYSTEMS,” which is incorporated herein by reference in its entirety.

### FIELD OF THE INVENTION

This invention relates to improved adherable flexible composite systems. More particularly, this invention relates generally to engineered flexible-composite compositions and, more particularly, to adhesive-containing compositions in the form of preformed tapes and sheets.

### BACKGROUND OF THE INVENTION

In most technical fields, developers and producers of commercial goods seek to continuously improve their production processes by reducing production costs while maintaining or improving the quality of the products being produced. Such technical innovation has been a significant driver in the growth of national and world economies, and will continue to be so in the future. Moreover, there exists a steady secondary demand for efficient and cost effective means for maintaining and modifying products structures, and components already in service.

Clearly, there will be a continuous demand for technical improvements, especially those having broad applicability in multiple technical fields, such as those presented in the following disclosure.

### SUMMARY OF THE INVENTION

In various aspects of the present disclosure, a system of adherable composites, which are configured to facilitate the design and construction of physical structures and components, is provided. It is another object and feature of the present disclosure to provide such a system facilitating the repair and maintenance of physical structures and components in such a way that they will maintain the use for which they are required, having due regard to their intended life and cost. It is a further feature of the present disclosure to provide a system of adherable composites, which are configured to structurally-orientable and structurally optimized for taped applications. Furthermore, the disclosure provides a system of manufacturing adherable composites that is efficient, inexpensive, and useful.

In accordance with various embodiments, a composite laminate tape can comprise a first fiber matrix layer having a first side and a second side, and an adhesive layer bonded to the second side of the first fiber matrix layer. The first fiber matrix layer can be a spread filament having monofilaments therein, the monofilaments lying in a first predetermined direction within the composite laminate tape. Moreover, various embodiments can include a method of manufacturing composite laminate tape, the method comprising forming at least one fiber matrix layer, wherein the at least one fiber matrix layer comprises a first fiber matrix layer, at least partially curing the first fiber matrix layer; and adding an adhesive layer after the at least partially curing of the first fiber matrix layer. The first fiber matrix layer can be a spread filament having monofilaments therein, the monofilaments lying in a first predetermined direction within the composite laminate tape.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description serve to explain the principles of the disclosure, wherein:

FIG. 1 shows a perspective view, illustrating an engineered preformed adhesive tape, in accordance with various embodiments;

FIG. 2 shows a perspective view, illustrating an engineered preformed adhesive sheet, in accordance with various embodiments;

FIG. 3 shows a front-surface view, illustrating an engineered preformed adhesive tape, in accordance with various embodiments;

FIG. 4 shows a front-surface view, illustrating an engineered preformed adhesive tape, in accordance with various embodiments;

FIG. 5 shows a sectional view, taken through portion of an engineered preformed adhesive tape, in accordance with various embodiments;

FIG. 6 shows a sectional view, taken through portion of an engineered preformed adhesive tape, in accordance with various embodiments;

FIG. 7 shows a sectional view, taken through portion of an engineered preformed adhesive tape, in accordance with various embodiments;

FIG. 8 shows a front-surface view, illustrating an engineered preformed adhesive tape, applied to members of a bonded seam, in accordance with various embodiments;

FIG. 9 shows a sectional view through this section 9-9 of FIG. 8; and

FIG. 10 shows a diagram illustrating an overlapping (wrapped) tapped configuration, in accordance with various embodiments.

### DETAILED DESCRIPTION OF THE INVENTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments, and that and that logical material, process order, and mechanical changes may be made without departing from principles of the present disclosure.

Brief Glossary of Terms and Definitions:
Adhesive: A substance capable of holding two materials together by surface attachment.
Anisotropic: Not isotropic; having mechanical and or physical properties which vary with direction at a point in the material.
Aerial weight: The weight of fiber per unit area, this is often expressed as grams per square meter (g/m²).
Autoclave: A closed vessel for producing an environment of fluid pressure, with or without heat, to an enclosed object which is undergoing a chemical reaction or other operation.
B-stage: Generally defined herein as an intermediate stage in the reaction of some thermosetting resins. Materials are sometimes pre cure to this stage, called “pre-pregs”, to facilitate handling and processing prior to final cure.
Cure: To change the properties of a thermosetting resin irreversibly by chemical reaction, i.e., condensation, ring closure, or addition. Cure may be accomplished by addition of curing (cross-linking) agents, with or without catalyst, and with or without heat.
Fiber: A general term synonymous with filament.
Fiber matrix: A spread filament (fiber network) embedded in a resin, wherein the resin may be any one of curable, non-curable or thermosetting resins or an adhesive polymer or thermoplastic polymer.
Filament: The smallest unit of a fiber-containing material. Filaments usually are of long length and small diameter.
Polymer: An organic material composed of molecules of monomers linked together.
Prepreg: A ready-to-cure sheet or tape material. The resin is partially cured to a B-stage and supplied to a layup step prior to full cure.
PSA: Pressure sensitive adhesive-Adhesives which form bonds when pressure is applied (also known as self-stick adhesives).
Resin: A general term synonymous with polymer, but used herein in the context of a reactive polymer (curable resin).
Spread filament: A network or web of oriented fibers.
Tack: Property of the material that enables it to form a bond immediately on contact with the surface. High tack is important in pressure-sensitive adhesive.
TPU: Thermoplastic polyurethane

In various embodiments, the present disclosure encompasses adherable flexible composite systems. An adherable flexible composite system in accordance with the present disclosure may comprise a set of engineered flexible-composite compositions, such as, but not limited to, a set of adhesive-containing flexible-composite compositions. Sets of adhesive-containing flexible-composite compositions may comprise various composite tapes and sheets. In various embodiments, flexible-composite compositions may comprise one or more layers of flexible fibers, such as non-woven fibers, embedded within a polymeric (resin) matrix.

General tape applications of the present system may include: wrapping; structural seaming and joining; covering; and patching.

Representative applications of the present system preferably include: assembly or repair of specialty and technical textiles, bond-line control in overlap seaming, pressurized vessel sealing and repair, bonding and seaming of engineered membranes, aerospace fabrication, assembly or repair of pressure garments, blast mitigation retrofitting, seismic retrofitting, and other applications requiring engineered control of force loads applied across joined components or within component sections.

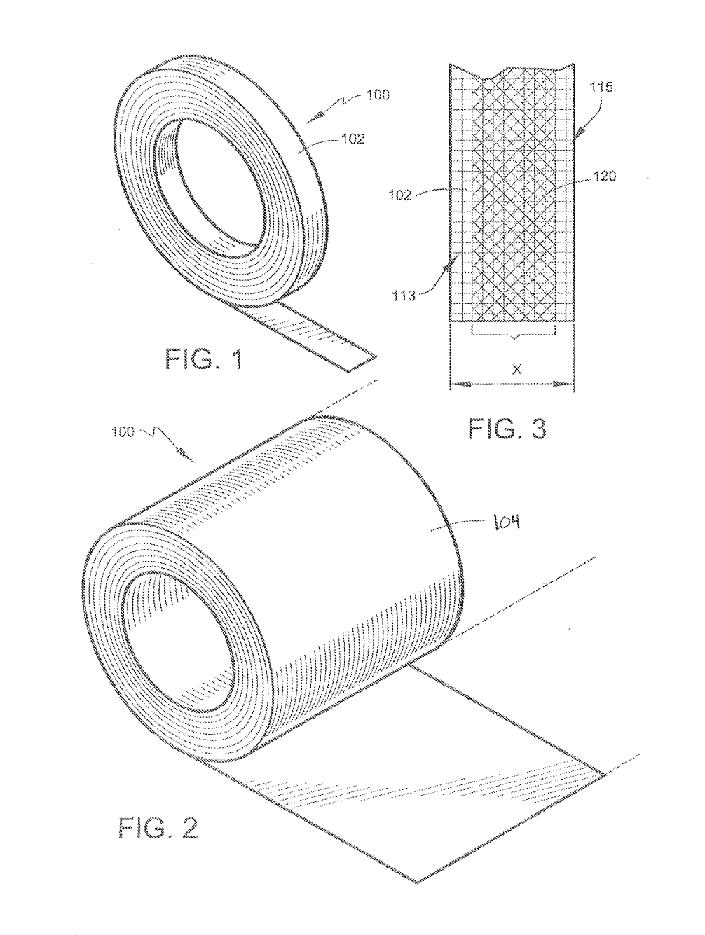

FIG. 1 shows in perspective view an embodiment of an adherable flexible composite system 100 comprising engineered preformed adhesive tape 102 in accordance with the present disclosure. Similarly, FIG. 2 shows in perspective view an embodiment of an engineered preformed adhesive sheet 104, in accordance with the present disclosure. Referring to both FIG. 1 and FIG. 2, adherable flexible composite system 100 preferably comprises a set of engineered flexible-composite compositions, more preferably, a set of adhesive-containing flexible composite compositions comprising tapes and sheets, as shown. Such preformed tapes and sheets of the present system can be configured to assist the assembly of physical components to form one or more larger structures. In particular, the adherable flexible composite system 100 can be useful in applications requiring an engineered control of force loads applied across joined component members.

Alternate preferred embodiments of adherable flexible composite system 100 can also be configured to provide structural enhancement, provide or restore fluid-pressure integrity, and provide engineered control of load paths in various structural joining applications.

With reference to FIG. 1 and FIG. 2, various embodiments of adherable flexible composite system 100 are supplied in rolled form, as shown. Alternatively, preferred embodiments of adherable flexible composite system 100 are supplied as flat-stackable sheets. Rolls may be of any size, such as for example, from less than 1 inch wide to over 5 feet wide. Also, larger rolls may be cut into rolls having smaller widths. Flat-stackable sheets may be of any shape (e.g. circular, rectangular, or square) to service a particular market segment, and may be of any size needed for a particular application within a particular market.

Referring now to FIG. 3, a front-surface view of an embodiment of an engineered preformed adhesive tape 102 in accordance with the present disclosure is illustrated. Engineered preformed adhesive tape 102 preferably comprises one or more flexible-composite compositions. Preferred composite materials combine two or more constituent materials to form a unified material composition. In general, preferred exemplary flexible-composite compositions comprise a polymer matrix 113 embedding an arrangement of flexible fibers 115. Such preferred flexible-composite compositions provide both mechanical flexibility and a relatively high strength-to-weight ratio.

In accordance with various embodiments, a composite laminate tape can comprise a first fiber matrix layer having a first side and a second side, and an adhesive layer bonded to the second side of the first fiber matrix layer. The first fiber matrix layer can be a spread filament having monofilaments therein, the monofilaments lying in a first predetermined direction within the composite laminate tape. The composite laminate tape can be configured to be elastic in a first direction and inelastic in a second direction. Further, the composite laminate can also comprise a release paper layer attached to the adhesive layer opposite the first fiber matrix layer. In other embodiments, the composite laminate tape can comprise a first film layer bonded to the first side of the first fiber matrix layer. The composite laminate layer can, in various embodiments, also include a second film layer attached to the adhesive layer opposite the first fiber matrix layer, wherein the second film layer acts as a release paper.

As disclosed herein in greater detail, the composite laminate tape can be configured to attach to at least two materials to form attached materials, and wherein the composite laminate tape forms a structural bond with the attached materials. Also, in various embodiments, an adhesive of the adhesive layer can be a pressure adhesive. The composite laminate tape can comprise a second fiber matrix layer between the first fiber matrix layer bonded to the first side of the first fiber matrix layer, wherein the second fiber matrix layer is a spread filament having monofilaments therein, the monofilaments lying in a second predetermined direction within the composite laminate tape. The second fiber matrix layer can have a narrower width then a width of the first fiber matrix layer. Moreover, a centerline of both the first fiber matrix layer and the second fiber matrix layer can be aligned. Th composite laminate tape can further comprise a third fiber matrix layer attached to the second fiber matrix layer opposite the first fiber matrix layer, wherein the third fiber matrix layer has a narrower width than the width of the second fiber matrix layer, and wherein a centerline of the third layer is aligned with the centerlines of the first and second fiber matrix layers.

The third fiber matrix layer can be a spread filament having monofilaments therein, the monofilaments lying in a third predetermined direction within the composite laminate tape. In various embodiments, the first predetermined direction, the second predetermined direction, and the third predetermined directions of the first, second, and third fiber matrix layers, respectively, can all be different. In addition, in various embodiments, the composite laminate tape can have an adhesive layer on both outer sides of the composite laminate tape. Moreover, the previously discussed layers of at least one film layer, at least one fiber matrix layer, and at least one release liner can be combined in various combinations and in various orders.

Still referring to FIG. 3, preferred embodiments of adherable flexible composite system 100 preferably comprise flexible polymeric composites of various selected widths, “X,” wherein X is up to about 10 meters. Such flexible polymeric composites may comprise various material weights, mechanical properties (e.g. to achieve compliance), and other compositional and mechanical attributes. In various embodiments, the flexible fibers may comprise non-woven fibers. For example, adherable flexible composite system 100 can comprise one or more layers of non-woven unidirectional (UD) fibers and polymer matrix plies oriented in one or more directions. Non-woven fibers for use herein may comprise, but are not limited to, spun-bonded fibers and melt-blown fibers.

“Spun-bonded fibers” refers to fibers formed by extrusion of molten thermoplastic material as filaments, described for example in U.S. Pat. Nos. 4,340,563 to Appel; U.S. Pat. No. 3,692,618 to Dorschner; U.S. Pat. No. 3,802,817 to Matsuki; U.S. Pat. No. 3,338,992 and U.S. Pat. No. 3,341,394 to Kinney; U.S. Pat. No. 3,502,763 to Hartman; U.S. Pat. No. 3,542,615 to Dobo; and, U.S. Pat. No. 5,382,400 to Pike, the entire contents of each incorporated herein by reference. Spun-bond fibers are generally not tacky when they are deposited onto a collecting surface. Spun-bond fibers are generally continuous and have average diameter from about 7 microns to about 60 microns, and most often between about 15 and 25 microns.

“Melt-blown” fibers refers to fibers formed by extruding molten thermoplastic material through a plurality of fine, normally circular, die capillaries as molten threads or filaments into converging high velocity, usually hot, gas/air streams that attenuate the filaments of molten thermoplastic material to reduce their diameter, which may end up to be clown to micro-fiber diameter. Thereafter the melt-blown fibers are carried by the high velocity gas stream and are deposited on a collecting surface to form a web of randomly dispersed meltdown fibers. Such a process is disclosed, for example, in U.S. Pat. No. 3,849,241. Melt-blown fibers are micro-fibers that may be continuous or discontinuous, and are generally smaller than 10 microns in average diameter, and are generally tacky when deposited onto a collecting surface.

Non-woven fibers may be produced from any suitable synthetic polymer or copolymer, such as, but not limited to, any one or combination of: polyethylenes, polypropylenes, polyethyleneterephthalates, polyurethanes, polystyrenes, polyesters, and polyacrylates, and derivatives thereof. Fibers for use herein may comprise any single polymer material, or a combination of several materials, such as in a sheath-core arrangement. Non-woven fibers may comprise fibers known as “bi-component fibers”, for example “sheath/core bi-component fibers”, which are fibers having an outer sheath area or layer with a lower melting point than the inner core area, allowing for efficient and controlled thermal bonding through melting of just the outer layer of each fiber. That is, the outer surface of a bi-component fiber can be made to have a lower melting point than the core of the fiber. For example, binder bi-component fibers where one component has adhesive properties under bonding conditions are widely employed to provide integrity to fibrous webs used as absorbents in personal care products or in filtration products. Examples of such multi-component fibers are described in U.S. Pat. Nos. 5,382,400 and 5,866,488.

A layer of non-woven unidirectional fibers in accordance with the present disclosure may comprise fibers bonded together at points where the fibers join and/or cross. For example, the fibers may be bonded at various fiber-to-fiber contact points to provide the desired stretch and strength directional characteristics of the particular flexible-composite composition. Fiber-to-fiber bonding can be achieved by either thermal fusion of adjacent fibers, or adhesive, bonding that is accomplished through incorporation of adhesives in the fibers to “glue” fibers together, or by other bonding, such as through the use of liquid or gaseous bonding agents (usually in conjunction with heating) to render the fibers cohesive. Chemical bonding may be accomplished through the use of adhesive or latex powders dispersed between the fibers in the web, which is then activated by heat, ultraviolet or infrared radiation, or other suitable activation method.

Those with ordinary skill in the art will now appreciate that, under appropriate circumstances, considering such issues as design preference, user preferences, cost, structural requirements, available materials, technological advances, etc., other arrangements such as, for example, use of woven and non-woven fabrics or sheet membranes, application of coatings, etc., may be included within any of the flexible-composite compositions herein. Nonwoven fabrics are well known to those skilled in the textiles art. Nonwovens are described in “Nonwoven Fabrics: Raw Materials, Manufacture, Applications, Characteristics, Testing Processes”, editors W. Albrecht, H. Fuchs and W: Kittelmann, Wiley-VCH Verlag GmbH & Co. KgaA Weinheim, 2003. Such fabrics can be prepared by forming a web of continuous filament and/or staple non-woven fibers and optionally bonding the fibers at fiber-to-fiber contact points to provide fabrics having the desired properties, amongst other methods. The term “bonded nonwoven fabric” is used to include nonwoven fabrics where a major portion of the fiber-to-fiber contact points are bonding as described above.

In various embodiments, a flexible-composite composition can comprise non-woven or other suitable fibers embedded in a polymer matrix or a resin to form a fiber matrix. The polymer can partially or fully occlude each of the fibers that make up any of the spread filaments. In various embodiments, the polymer may also function as an adhesive in the adherable flexible composite system. The polymer used in combination with a spread filament for a particular fiber matrix herein may comprise any nonionic, cationic, anionic, or amphoteric polymer or co-polymer, including any synthetic or naturally occurring material, or any synthetically modified naturally occurring polymer, with any degree of cross-linking or other intra- or inter-molecular modification thereof. These polymers may be curable, non-curable, or thermoset. Curable resins for use herein may be partially or fully curable, and may be chemically or thermally curable, or cured with any degree and type of radiation. In this way, a spread filament may be coated with a resin and then partially or fully cured such that the spread filament is embedded within the resin.

In various embodiments, tapes can be specifically engineered for their intended applications. The stacking sequence of constituent fiber lamina may vary between embodiments, that is, the preferred configuration of a composite laminate with regard to the angles of layup, the number of lamina at each angle, and the exact sequence of the lamina layup may vary by application. Preferred embodiments of the present system may comprise substantially symmetric fiber laminations. For example, preferred tapes may comprise lamina types, angles, and aerial weights exactly mirrored about a given axis of the composite. Alternate preferred embodiments of the present system comprise asymmetric structures.

In regard to the above-described preferred design variations, the physical properties of some preferred composite tapes are generally isotropic, meaning that the composite tape has substantially the same physical properties in all directions. For example, it may be desired that a particular composite tape stretch to the same degree in all directions. In various other embodiments, such as to provide specific engineered control of force loads and/or to optimize other performance factors, physical properties of the composite can be anisotropic, meaning that the composite tape has various non-uniform mechanical and or other physical characteristics in order to structurally optimize performance to match a specific application. For example, it may be desired that a particular composite tape stretch in only a longitudinal direction and not at all in a latitudinal direction.

With reference again to FIG. 3, the composite tape illustrated comprises a central concentration of fiber lamina. That is, the composite tape comprises fewer fibers along its peripheral edges. To achieve this characteristic change in cross-sectional thickness, one or more reinforcement layers can be ended before reaching the opposing peripheral edges. That is, a reinforcement layer can have a smaller width than a base layer onto which it is layered. A cross-section of this preferred embodiment type is diagrammatically depicted in FIG. 6, discussed herein below.

The peripheral drop-off of reinforcement fibers in the composite illustrated in the embodiment of FIG. 3 functions to generate a more uniform stress distribution across the tape when applied over a seamed joint. This preferred arrangement preferably reduces the magnitude of the stress risers at the peripheral edges of the tape, allowing the joint to be more uniformly loaded. It is further noted that this engineered arrangement also functions to reduce the peel stresses at the peripheral edges of the tape. In addition, the variable thickness also allows tape overlap with minimal thickness buildup. This particular feature is useful when the tape is used to overwrap piping for purposes of reinforcement.

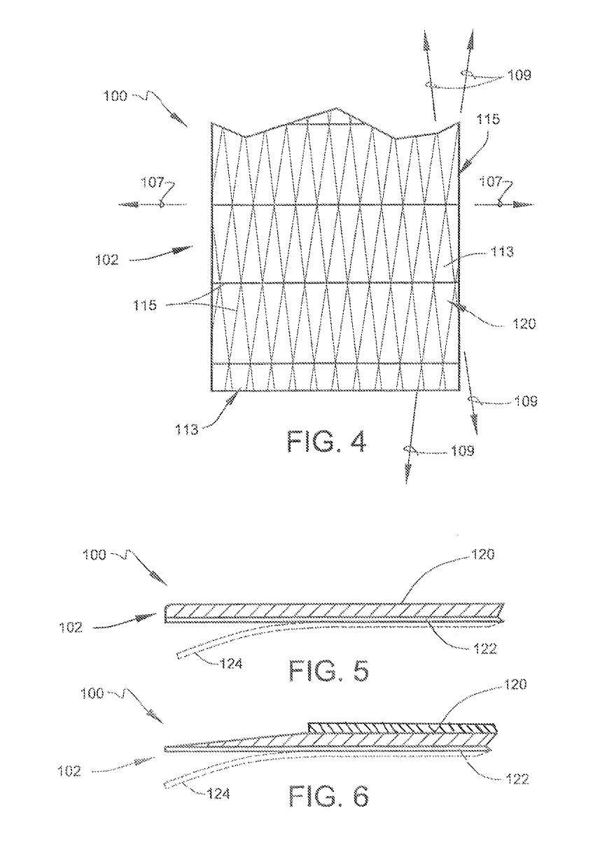

Referring now to FIG. 5, another preferred embodiment of the present system is illustrated, wherein the tape is comprises a uniform thickness. This alternate preferred embodiment with a uniform thickness provides a smooth and flat seam in various installations. Although the embodiment of FIG. 5 comprises uniform thickness, the tape may nonetheless comprise asymmetric mechanical properties. Asymmetrical properties may be introduced in a composite tape having a uniform thickness by careful engineering of the weight, spacing, and orientation of the constituent fibers, as discussed herein below (FIG. 4).

FIG. 4 illustrates a front-surface view of a preferred embodiment of an engineered preformed adhesive tape 102 in accordance with the present disclosure. It should be noted that the placement of fibers depicted in FIG. 4 and the other drawing figures herein do not necessarily represent actual quantities or spacing of constituent fibers or filaments. The composite of FIG. 4 comprises an engineered fiber arrangement having a greater number of fiber orientations aligned adjacent the longitudinal axis relative to fibers oriented transversely to the longitudinal axis.

In a preferred embodiment, the composite tape of the present system comprises a fiber reinforcement lamina in a first orientation 107 minimally sufficient to carry necessary shear loads and to stabilize the structure. Additional fiber reinforcement lamina 109 of the flexible composite may comprise more or less reinforcement, as required by the force loading anticipated within the particular application.

FIG. 5 shows a sectional view, taken through portion of an engineered preformed adhesive tape 102, according to preferred embodiments of the present invention. Preformed adhesive tape 102 preferably comprises at least one structural composite-tape portion 120 and at least one adhesive layer 122, as shown. In addition, preferred embodiments of the present system comprise a release paper 124 (or layer or film) attached to the adhesive layer, as diagrammatically indicated by the dashed-line depiction. For the release layer, any conventional release liner or their laminates used may be used. For example, a film, a paper, or laminates thereof, made of polyethylene, polyester, polyvinyl chloride, polyvinylidene chloride, and the like, optionally coated with silicone resin or fluoride resin, may be used herein.

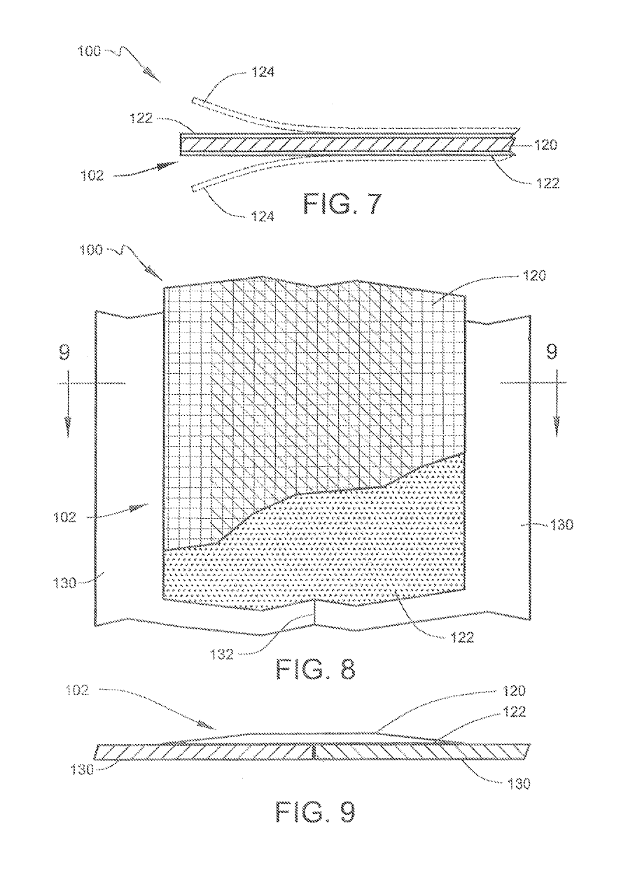

FIG. 7 shows a sectional view, taken through portion of a double-sided adhesive tape 102, in accordance to various embodiments of the present disclosure. The preformed adhesive tape 102 illustrated preferably comprises the structural composite-tape portion 120 and at least two adhesive layers 122, as shown. As above, some preferred embodiments of the present system can utilize one or more layers of release paper 124 attached to the adhesive layers, as diagrammatically indicated by the dashed-line depictions.

The following are non-limiting examples of adhesive types that can be used herein. The various adhesive types can include, but are not limited to, 1) Non-reactive pressure-sensitive adhesive (PSA), 2) Reactive PSA, 3) Reactive thermoplastic polyurethane (TPU), 4) Thermoplastic Hot melt (HM), 5) Cross-linked HM, 6) Spun Bond and Fused Powder, or 7) Liquid Adhesive.

Furthermore, the following non-limiting methods are useful for applying various adhesives to tape and also for applying any curable, thermosetting, or non-curable resin over and into a spread filament to produce an engineered fiber matrix composite layer:
1) Solution Coated with drying oven or heat-transfer roll
2) 100% solids liquid “B” staged to tacky or semi-tacky layer “B” stage may be thermal, radiation, UV, room temp catalyst or polymerization
3) Calender application/lamination of preformed reactive or non-reactive PSA, alternately preferably TPU, alternately preferably Spun Bond, or alternately preferably hot-melt films
4) Calender application bulk adhesive reactive or non-reactive PSA, alternately preferably TPU or alternately preferably hot melt adhesives
5) Slot-die coating of bulk adhesive reactive or non-reactive PSA, alternately preferably TPU or alternately preferably hot melt adhesives
6) Reverse Roll Coating or Knife-Over-Roll coating of reactive or non-reactive PSA, alternately preferably TPU or alternately preferably hot-melt adhesives
7) Graveure coating of reactive or non-reactive PSA, alternately preferably TPU or alternately preferably hot melt adhesives
8) Spray coating of reactive or non-reactive PSA, alternately preferably TPU or alternately preferably hot melt adhesives
9) Inkjet or roll printing of adhesive reactive or non-reactive PSA, alternately preferably TPU or alternately preferably hot melt adhesives
10) Direct application of Spun Bond Adhesive.
11) Metered bead/bead, stripes or dot application 100% solids liquid adhesive, alternately preferably solution resins and reactive or non-reactive PSA, alternately preferably TPU or alternately preferably hot-melt adhesives
12) In the field metered application of 100% solids liquid adhesive, alternately preferably solution resins and reactive or non-reactive PSA, alternately preferably TPU or alternately preferably hot melt adhesives (this method is especially important when high adhesive flow and absorption or wetting out of the substrate is desired. It is also desirable when high volumes of adhesive or especially thick layers are needed)
13) Direct use of the resin matrix for bonding. Matrix may be uncured or B-stage cross-linking resin, reactive or non-reactive PSA, alternately preferably TPU or alternately preferably hot melt adhesives.

Moreover, in various embodiments, separator types for unrolling or removing from flat stacks can include:
1) Use of single or double-sided release paper 124 or alternately preferably film attached to adhesive layer 122.
2) Use of single or double sided release paper 124 or film as interleaf
3) Use of release-treated, non-stick, or non-bondable surface on side of tape opposite adhesive layer 122 to allow unrolling of tape.
4) Use of non-tacky or low-tack adhesive layer 122, such as, for example TPU, alternately preferably Hot Melt, alternately preferably Spun Bond HM, or alternately preferably fused or electrostatic HM-powder adhesive

FIG. 8 illustrates a front-surface view of an embodiment of an engineered preformed adhesive tape 102 applied to substrates to be bonded, in accordance with the present disclosure. The engineered preformed adhesive tape 102 is shown applied to and covering a bonded seam 132. An adhesive layer 122, shown by way of a cut-away depiction, may comprise a non-tacky or low-tack adhesive as desired for a particular substrate and application.

FIG. 9 shows a sectional view through this section 9-9 of FIG. 8. In this embodiment, the cross-section of the engineered preformed adhesive tape 102 is non-uniform, such as from the use of reinforcement layers that do not extend out to the peripheral edges of the tape, or wherein narrower reinforcement composites are layered onto wider layers to create stepped lamina, as discussed above.

The following section describes non-limiting methods of applying and bonding an adhesive layer of an engineered preformed adhesive tape 102 to various bonding substrates 130, such as depicted in FIGS. 8 and 9:

In accordance with various embodiments, there are multiple methods of applying and bonding adhesive layers of seam tape to a bonding substrate. By way of example, provided herein are some of those methods. The methods may not include all of the listed steps, and the steps may occur in various orders as would be understood by one skilled in the art. A first method can comprise contact between an adhesive layer of seam tape and bonding substrate, while adding pressure, heat, and/or non-thermal activation if reactive adhesive or substrate. The different steps can include applying adhesive via hand, roller, or fixture pressure, adding pinch-roll lamination, processing in a vacuum and/or autoclave. Processing through a platen press, submitting to a belt press/fuser, and subjecting to bladder pressure.

A second method can include a heat fused TPU, hot melt, spun bond HM, or fused or electrostatic HM powder adhesive, with various steps as described with respect to the first method. Moreover, a third method can include liquid or reactive PSA or hot melt, with various steps as described with respect to the first method.

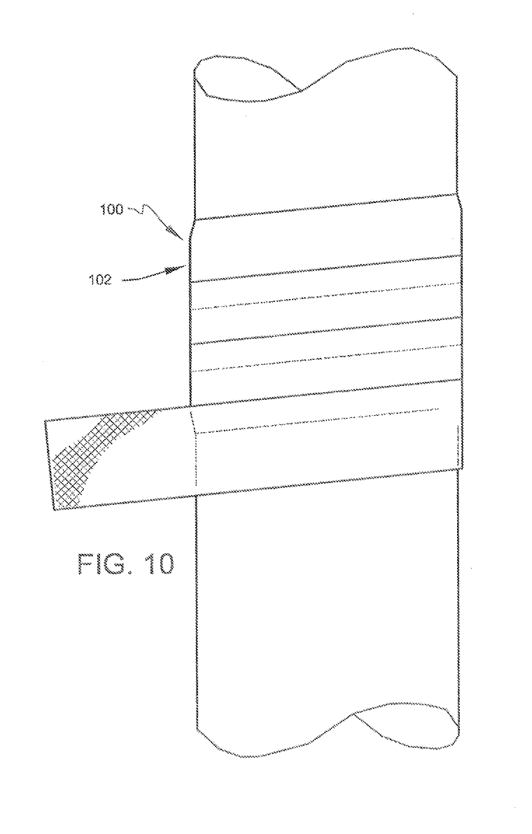

In a fourth exemplary method, adhesive application can include in-the-field metered application of the adhesive. The method can include various steps as described with respect to the first method, and that any of the various steps can be combined with a UV or radiation cure process. Moreover, a wrapping or winding method, such as illustrated in FIG. 10, can include a) and, roller, or fixture pressure, b) pinch-roll lamination, c) vacuum/autoclave, d) bladder pressure, and e) any of the above can be combined with UV or radiation cure processes

Preferred seam configurations can include stress confuser (separation of stress contributors), single side, double reinforcement, overlap, and/or bondline control. Furthermore, adhesive bonding factors include adhesive flow, and surface treatments to improve bonding. The surface treatments can include corona, plasma, fluoride, silane, primer, and/or nano spray. Other adhesive bonding factors include moisture, surface texture, and stability of substrate surface (e.g. ensure free of debris, etc.).

It will be to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

Related disclosures for providing additional information related to coloration of membranes, fire retardant additives, and anti-microbial additives are found in U.S. Pat. No. 5,470,062, entitled “COMPOSITE MATERIAL FOR FABRICATION OF SAILS AND OTHER ARTICLES,” which was issued on Nov. 28, 1995; and U.S. Pat. No. 5,333,568, entitled “MATERIAL FOR THE FABRICATION OF SAILS” which was issued on Aug. 2, 1994; and U.S. patent application Ser. No. 13/168,912, filed Jun. 24, 2011 entitled “WATERPROOF BREATHABLE COMPOSITE MATERIALS FOR FABRICATION OF FLEXIBLE MEMBRANES AND OTHER ARTICLES,”; and U.S. patent application Ser. No. 13/197,741, filed Aug. 3, 2011 entitled “SYSTEM AND METHOD FOR THE TRANSFER OF COLOR AND OTHER PHYSICAL PROPERTIES TO LAMINATE COMPOSITE MATERIALS AND OTHER ARTICLES”, the contents of all of which are hereby incorporated by reference in their entirety.

Likewise, numerous characteristics and advantages have been set forth in the preceding description, including various alternatives together with details of the structure and function of the devices and/or methods. The disclosure is intended as illustrative only and as such is not intended to be exhaustive. It will be evident to those skilled in the art that various modifications may be made, especially in matters of structure, materials, elements, components, shape, size and arrangement of parts including combinations within the principles of the disclosure, to the full extent indicated by the broad, general meaning of the terms in which the appended claims are expressed. To the extent that these various modifications do not depart from the spirit and scope of the appended claims, they are intended to be encompassed therein.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “includes,” “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

What is claimed is:

1. A composite laminate tape comprising:
a first fiber matrix layer having a first side and a second side, wherein the first fiber matrix layer is a spread filament having monofilaments therein, the monofilaments lying in a first predetermined direction within the composite laminate tape; and
an adhesive layer bonded to the second side of the first fiber matrix layer.

2. The composite laminate tape of claim 1, wherein the composite laminate tape is configured to be elastic in a first direction and inelastic in a second direction.

3. The composite laminate tape of claim 1, further comprising a release paper layer attached to the adhesive layer opposite the first fiber matrix layer.

4. The composite laminate tape of claim 1, further comprising a first film layer bonded to the first side of the first fiber matrix layer.

5. The composite laminate tape of claim 4, further comprising a second film layer attached between the adhesive layer and the first fiber matrix layer.

6. The composite laminate tape of claim 5, further comprising a release paper layer attached to the second film layer opposite the adhesive layer.

7. The composite laminate tape of claim 1, wherein the composite laminate tape is configured to attach to at least two materials to form attached materials, and wherein the composite laminate tape forms a structural bond with the attached materials.

8. The composite laminate tape of claim 1, wherein an adhesive of the adhesive layer is a pressure sensitive adhesive.

9. The composite laminate tape of claim 1, further comprising a second fiber matrix layer between the first fiber matrix layer bonded to the first side of the first fiber matrix layer, wherein the second fiber matrix layer is a spread filament having monofilaments therein, the monofilaments lying in a second predetermined direction within the composite laminate tape.

10. The composite laminate tape of claim 9, wherein the second fiber matrix layer has a narrower width then a width of the first fiber matrix layer.

11. The composite laminate tape of claim 10, wherein a centerline of both the first fiber matrix layer and the second fiber matrix layer are aligned.

12. The composite laminate tape of claim 11, further comprising a third fiber matrix layer attached to the second fiber matrix layer opposite the first fiber matrix layer, wherein the third fiber matrix layer has a narrower width than the width of the second fiber matrix layer, and wherein a centerline of the third layer is aligned with the centerlines of the first and second fiber matrix layers.

13. The composite laminate tape of claim 12, wherein the third fiber matrix layer is a spread filament having monofilaments therein, the monofilaments lying in a third predetermined direction within the composite laminate tape.

14. The composite laminate tape of claim 13, wherein the first predetermined direction, the second predetermined direction, and the third predetermined directions of the first, second, and third fiber matrix layers, respectively, are all different.

15. A method of manufacturing composite laminate tape, the method comprising:
forming at least one fiber matrix layer, wherein the at least one fiber matrix layer comprises a first fiber matrix layer, wherein the first fiber matrix layer is a spread filament having monofilaments embedded in a resin therein, the monofilaments lying in a first predetermined direction within the composite laminate tape;
at least partially curing said resin; and
adding an adhesive layer onto said fiber matrix layer after the at least partially curing of said resin.

16. The method of claim 15, wherein the at least one fiber matrix layer comprises a second fiber matrix layer, wherein the second fiber matrix layer is a spread filament having monofilaments embedded in a resin therein, the monofilaments lying in a second predetermined direction within the composite laminate tape.

17. The method of claim 16, wherein the at least one fiber matrix layer comprises a third fiber matrix layer, wherein the third fiber matrix layer is a spread filament having monofilaments embedded in a resin therein, the monofilaments lying in a third predetermined direction within the composite laminate tape.

18. The method of claim 17, further comprising designing an elasticity and strength of the composite laminate tape by determining the predetermined directions of the first, second, and third predetermined directions of the first, second, and third fiber matrix layers, respectively.

19. The method of claim 18, wherein the composite laminate tape is a multi-directional material with designed elasticity and strength attributes in all directions.

20. The method of claim 18, wherein the first predetermined direction, the second predetermined direction, and the third predetermined directions of the first, second, and third fiber matrix layers, respectively, are all different.
